(19) United States
(12) Patent Application Publication
(10) Pub. No.: US 2014/0324490 A1
(43) Pub. Date: Oct. 30, 2014

(54) Distributed Farm Optimization System

(71) Applicant: Michael H. Gurin, Glenview, IL (US)

(72) Inventor: Michael H. Gurin, Glenview, IL (US)

(21) Appl. No.: 13/872,339

(22) Filed: Apr. 29, 2013

(51) Int. Cl. G06Q 10/06

(52) U.S. Cl. CPC G06Q 10/0631
USPC 705/7.12

(57) ABSTRACT

The growing management system optimizes peak aggregate nutrients normalized against aggregate delivered cost for edible plants including vegetables, herbs and fruits. This growing management system enables each plant harvested for consumer maximized nutrient and/or flavor value, not for farmer or distribution profit maximization, with more specific objective of harvesting at time of immediate consumer consumption.

### FIELD OF THE INVENTION

The present invention generally relates to farming, in any method ranging from vertical, greenhouse, and hydroponic to aeroponic, and whether it be in environmentally controlled conditions or uncontrolled conditions (e.g., entirely outdoor illuminated by the sun, whether watered as by nature and/or supplemented by water irrigation systems).

### BACKGROUND OF THE INVENTION

This invention addresses when the most beneficial time to harvest produce is based on nutrient optimization. Historically, growers were paid a certain price by weight whether per bushel or per pound. Therefore, measures of success were determined by how many bushels or pounds could be produced. This traditional metric was solely price-driven. In the past, the level of nutrients in the harvested produce was not taken into consideration.

Others have evaluated and made dietary recommendations on the consumption of nutrient dense fruits and vegetables based on the levels of micronutrients where the density is purely correlated with the fewest calories (e.g., Joel Fuhrman, M.D.). Today, with food being grown and shipped from far away and/or being harvested early and artificially ripened with chemicals the amount of nutrients consumers are actually receiving has been adversely impacted. Harvard Medical School's Center for Health and the Global Environment has shown that foods grown far away that spend significant time on the road have more time to lose nutrients before reaching the marketplace. In other words, consuming fruits and vegetables, all things equal, that are more devoid of nutrients defeats the purpose of consuming such fruits and vegetables in the first place.

Plants make a variety of compounds, many of which act as antioxidants when consumed. In reality, it is understood that plants in their natural form are superior to pure and highly processed antioxidants as compared to the full range of micronutrients present in live plants. Plants produce a unique pattern of reaching their maximum nutrient compound capacity, which is often concurrent with maximum flavor compound capacity. A landmark study by Donald Davis and his team of researchers from the University of Texas (UT) at Austin's Department of Chemistry and Biochemistry was published in December 2004 in the Journal of the American College of Nutrition. They studied U.S. Department of Agriculture nutritional data from both 1950 and 1999 for 43 different vegetables and fruits, finding “reliable declines” in the amount of protein, calcium, phosphorus, iron, riboflavin (vitamin B2) and vitamin C over the past half century. Davis and his colleagues chalk up this declining nutritional content to the preponderance of agricultural practices designed to improve traits (size, growth rate, pest resistance) other than nutrition. “Efforts to breed new varieties of crops that provide greater yield, pest resistance and climate adaptability have allowed crops to grow bigger and more rapidly,” reported Davis, “but their ability to manufacture or uptake nutrients has not kept pace with their rapid growth.” There have likely been declines in other nutrients, too, he said, such as magnesium, zinc and vitamins B-6 and E, but they were not studied in 1950 and more research is needed to find out how much less we are getting of these key vitamins and minerals. This further validates the requirement for the disclosed invention, a system to maximize nutrient and flavor and NOT to maximize revenue as traditionally directly correlated with weight of fruits and vegetables.

It is understood in the background that a wide range of sensors, ranging from spectrum analyzers (i.e., optical, and generally real-time and non-destructive) to chemical analyzers (i.e., GC mass spec, generally not real-time and destructive testing), exists in the art.

Furthermore, it is understood that plants grow (in nature as provided by the sun) the full light spectrum. Testing, originally attributed to space exploration, has lead to a more detailed understanding that red and blue are the two primary colors necessary to complete photosynthesis—the energy conversion where the plant transforms light into food and oxygen. The amount of red and blue light within a light source will affect plant growth in different ways. Blue light regulates the rate of a plants growth and is especially helpful in plants with lots of vegetation and few to no flowers. Blue light regulates many plant responses including stomata opening and phototropism. Stomata are openings on or beneath the surface of the leaves. A plant's moisture loss is primarily due to the stomata and blue light controls the degree of stomata opening, therefore blue light regulates the amount of water a plant retains or expels. Phototropism is the definition of a plant's response to light; the stems grow up toward the light and the roots grow down, away from the light. Metal halide grow lights emit more light in the blue spectrum and are the best source of indoor lighting to use for plant growth if there is no sunlight available. Red and orange light triggers hormones in plants that increase flowering and budding, but plants cannot grow with red light alone. They also need blue light to help regulate other types of responses. Red light stimulates flowering and foliage growth, but too much red light will cause a plant to become spindly. HPS (high-pressure sodium) grow lights emit a red orange glow and are excellent companion lights for growing conditions that include some natural sunlight or other light sources with high levels of blue light. Red light induces germination and blue light promotes seed growth, but far-red light inhibits germination.

Furthermore, it is understood that several phases of plant growth and resultant nutrient capacity are measured. Phase I is the early/immature stage of plant growth. During Phase I the plant has not reached the maximum peak potential of growth or nutrient optimization. Phase II is the mature stage of plant growth. During Phase II the plant has reached peak growth as well as peak nutrient optimization. Phase III is the post-mature stage of plant growth. During Phase III the plant is typically past the stage of optimal nutrient levels.

### SUMMARY OF THE INVENTION

The present invention preferred embodiment relates to the decoupling of the sales of fruits and vegetables from predominantly weight based pricing to a system based on cumulative nutrient and/or flavor delivery.

Another embodiment of the invention is the growing management system that maximizes the nutrient and/or flavor profile in fruits and vegetables being grown.

Yet another embodiment of the invention is the growing management system determining the optimal harvesting time by minimizing cost on a delivered nutrient/flavor aggregate as compared to the traditional maximization of revenue on a purely weight basis.

Another embodiment of the invention is the growing management system within a distributed farm system so as to minimize the post harvest loss of nutrients/flavor.

Yet another embodiment of the invention is the growing management system within a distributed farm system so as to maximize nutrient delivery for concurrent harvest and then consumer consumption so as to eliminate post harvest loss of nutrients/flavor and maximization of nutrient delivery while minimizing growing cost on a normalized nutrient/flavor basis.

Another embodiment of the invention is the growing management system to modulate consumer formulations in a real-time basis normalized on a nutrient/flavor basis, and not the traditional weight based consumer formulation.

Yet another embodiment of the invention is the growing management system utilizing a motion based automated harvesting system having an onboard real-time nutrient measurement sensor, such that travel routing from a start location to an ending location is optimized for updating products closest to their anticipated harvesting time.

Another embodiment of the invention is the growing management system utilizing a nutrient/flavor blasting system to maximize nutrient/flavor levels for a projected and/or actual consumption time as compared to store delivery time. The blasting system, in combination with sensors provides a precise blast of the appropriate red and/or blue spectrum for a specified number of hours to significantly increase the nutrients.

Yet another embodiment of the invention is the growing management system optimizing air exchange between the farm and a consumer located space to maintain a desired oxygen to carbon dioxide ratio, as compared to the traditional carbon dioxide ppm basis for consumer located spaces.

Another embodiment of the invention is a co-located consumer located space with a growing farm and a carbon dioxide producing system to minimize heating and cooling losses due to air exchange within consumer located space.

### BRIEF DESCRIPTION OF THE DRAWINGS

FIG. 1 is a process logic diagram describing the process of determining time to harvest in an uncontrolled farm.

FIG. 2 is a process logic diagram describing the process of determining time to harvest in a controlled farm.

FIG. 3 is an illustration representing the plant growing set up in a controlled farm for a vertical farm.

FIG. 4 is an illustration representing the plant growing set up in a controlled farm for a hydroponic farm.

FIG. 5 is an illustration representing the plant growing set up in a controlled farm for an aeroponic farm.

FIG. 6 is an illustration representing the plant growing set up in an uncontrolled farm.

FIG. 7 is a table depicting when nutrients are optimized over time.

FIG. 8 is a table depicting when nutrients are maximized for overall cost.

FIG. 9 is a table that shows some testing that was done showing that nutrients are lost post-harvest. In two days nearly 50% of the value of chlorophyll was lost in the kale that was tested.

FIGS. 10A, 10B, and 10C is a table depicting 3 different time scale graphs showing the inflection points for determining optimal harvest time.

FIG. 11 is a process logic diagram for optimal harvesting selection and real-time formulation adjustments.

FIG. 12 is a top down view (or cross-sectional view when vertical farm) of a farm and a component layout of the plant harvesting system.

FIG. 13 is a hybrid process logic diagram with component layout of the oxygen to carbon dioxide ratio air exchange system.

### DETAILED DESCRIPTION OF THE INVENTION

The term “controlled farm”, as used herein, includes any type of indoor farming such as a greenhouse, hoop house, vertical farm, aeroponic, hydroponic or aquaponic farm. These various types of indoor farms control the environment to varying degrees including lighting, temperature and irrigation.

The term “uncontrolled farm”, as used herein, includes any type of outdoor farming. These types of farms do no control for environmental factors such as lighting, temperature and irrigation and are subject to natural variations in sunlight, temperature and rainfall.

The term “nutrient optimization”, as used herein, includes methodologies to determine the more precise point in the growth of a plant such that the peak amounts of nutrients are delivered at the time of consumption. When the precise knowledge of consumption is not known, the peak amounts of nutrients are determined for harvest and/or packaging time. Nutrient optimization also refers to that precise point when the plant has reached the inflection point of nutrient normalized over the fully time amortized cost basis. It is understood that nutrients and flavors are used interchangeably in this invention, as nutrient and flavor compounds are closely linked at worst and at best are one of the same. Any use of nutrient optimization can be substituted for flavor optimization.

The term “sensors”, as used herein, includes devices to measure important parameters for growing plants. These parameters include light level, temperature, carbon dioxide levels, oxygen levels, water levels, plant intake nutrients, and plant produced nutrients.

The term “O2:CO2”, as used herein, is the ratio of oxygen to carbon dioxide present in the environmental air present. Air exchange in the context of consumer located spaces is currently based entirely on carbon dioxide ppm (parts per million), as absent of a co-located farm it is impractical to raise the amount of oxygen on a ppm basis without a complete fresh air exchange. Furthermore, it is equally impractical to raise the amount of oxygen for many combustion processes unless specific radiant qualities are desired due to the cost of oxygen generating equipment. However, a co-located oxygen-generating source enables superior cost effective recovery of waste heat from a co-located combustion process.

Here, as well as elsewhere in the specification and claims, individual numerical values and/or individual range limits can be combined to form non-disclosed ranges.

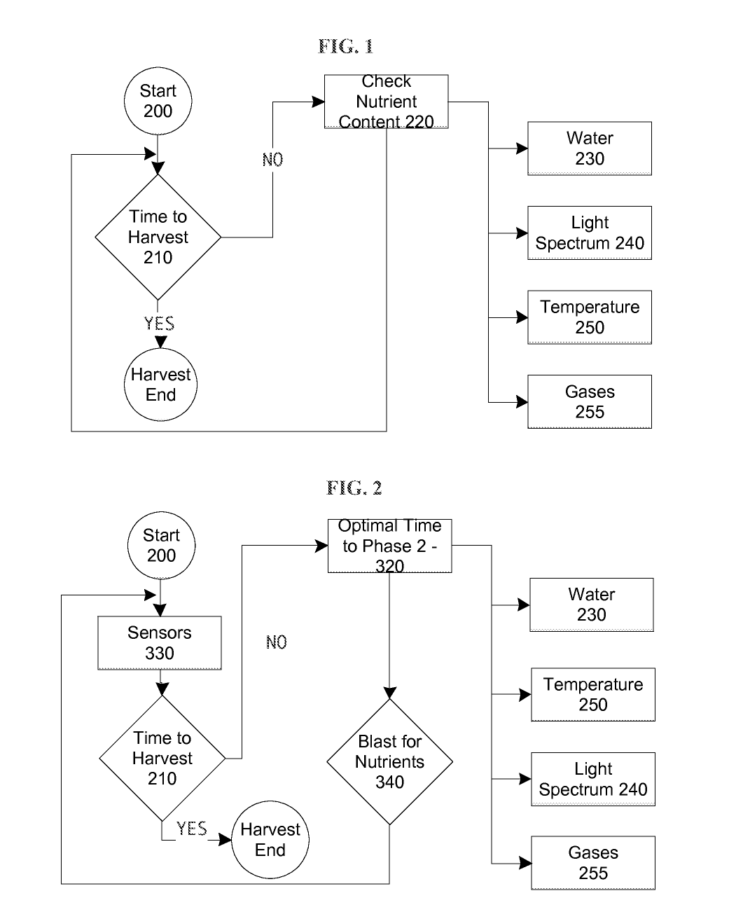

Exemplary embodiments of the present invention will now be discussed with reference to the attached Figures. Such embodiments are merely exemplary in nature. Furthermore, it is understand as known in the art that sensors to measure nutrient and flavor properties are placed throughout the embodiments as known in the art, most notably positioned to measure at least one plant parameter. The utilization of actuators and/or valves as standard mass flow regulators is assumed (i.e., not depicted) to be as known in the art and can also include variable flow devices, two way or three way valves. With regard to FIGS. 1 through 13, like reference numerals refer to like parts.

Turning to FIG. 1, FIG. 1 is a flowchart diagramming the process of determining the time to harvest plants for an uncontrolled farm. The process begins at the start 200 with the first decision point as to whether it is time to harvest 210. If yes, it is time to harvest the plant then end the process. If no, continue to check the nutrient content 220 of the plant. Checking the nutrient content 220 includes several steps: one step is to check the amount of water 230 in the soil; another is to check the light spectrum 240 that the plant is receiving; another is to check the temperature 250 of the environment and the gases within the environmental air 255 where the plant is growing. The decision point of time to harvest 210 is repeated until such as the answer is yes, which culminates in harvesting. It is understood that checking for the aforementioned growing conditions is anticipated to be both instantaneous and cumulative (i.e., time weighted average). Furthermore, it is noted that checking as known in the art is such that a measurement is obtained and compared to either a setpoint or an acceptable range threshold. Any corrective action, when such a condition is controllable, can be taken such as increasing light levels by using lighting sources including by example LEDs, fluorescent lighting, or high intensity discharge lighting. Corrective action for temperature includes heating or cooling as known in the art. Corrective action for water is practically limited to increasing water levels when conditions are too dry. Corrective action for gases, notably oxygen and/or carbon dioxide or C2:CO2 ratio includes the addition of carbon dioxide, the addition of oxygen, or the optimal being selective removal of oxygen particularly when the growing environment is co-located to a consumer located space and/or combustor whether that combustor is for heat or power generation.

Turning to FIG. 2, FIG. 2 is a flowchart diagramming the process of determining the time to harvest plants for a controlled farm. The process begins at the start 200 with a range of measurements through sensors 330 for the purpose of determining proper time to harvest, notably nutrient and flavor levels. The first decision point as to whether it is time to harvest 210. If yes, it is time to harvest the plant and end (harvest) the process. If no, the process continues by entering into Phase II of the growth stage 320 that includes measuring a series of conditions (repeated as depicted in FIG. 1) including water 230, temperature 250, light spectrum 240, and gases 255. The next decision point is to determine whether it is the optimal time to enter into Phase II of the growth stage 340. Entering Phase II of the growth stage includes changing any of the aforementioned conditions, notably the light spectrum to increase the nutrient and/or flavor levels. It is understood that an increase in nutrient and/or flavor levels is not sustainable as it places more extreme conditions on the plant, which without being bound by theory, stresses the plant. The stress on the plant is therefore a short-term condition that is optimized for nutrient and/or flavor levels to occur at the projected (or actual) crop harvest consumption. It is understood that this blast stage shortens the subsequent shelf life time and thus is virtually always avoided except when the farm is in relatively close proximity to the consumer. The particularly preferred proximity is either within the consumer located space or co-located (i.e., adjacent) to the consumer located space. The decision point of whether it is time to harvest is repeated until a positive condition is obtained at which time harvesting takes place and therefore ends (harvest) the process. It is understood that the optimization system determines the beginning and ending period for the plant to be blasted, such that the plant is at peak nutrient or flavor level at the time of consumption (i.e., blasting period).

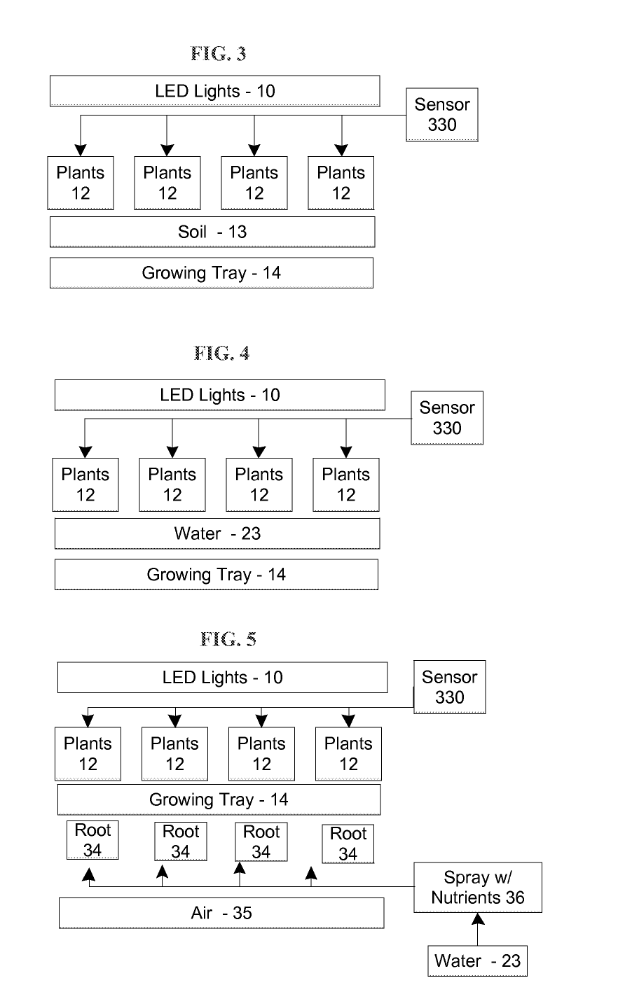

Turning to FIG. 3, FIG. 3 illustrates the nutrient optimization set-up for a controlled farm, specifically a vertical farm. This diagram shows the LED lights 10 needed to provide appropriate spectrum lights to the plants 12. The diagram further shows the sensors 330 that are part of the software management system to determine nutrient optimization and time to harvest. The diagram also shows the soil 13 that the plants grow in and the growing tray 14 needed to support the plants to grow in a controlled farm. It is understood that a vertical farm is comprised of repeating layers/stacks as each individual layer is depicted.

Turning to FIG. 4, FIG. 4 illustrates the nutrient optimization set-up for a controlled farm, specifically a hydroponic farm. This diagram shows the LED lights 10 needed to provide appropriate spectrum lights to the plants 12. The diagram further shows the sensors 330 that are part of the software management system to determine nutrient optimization and time to harvest. The diagram also shows the water 23 that the plants are grown in and the growing tray 14 needed for the plants to grow in a controlled farm.

Turning to FIG. 5, FIG. 5 illustrates the nutrient optimization set-up for a controlled farm, specifically an aeroponic farm. This diagram shows the LED lights 10 needed to provide appropriate spectrum lights to the plants 12. The diagram further shows the sensors 330 that are part of the optimization management system to determine nutrient optimization and time to harvest. The diagram also shows the roots of the plants 34 that extend through the growing tray 14 and are exposed to air 35. The diagram also shows a spray w/ nutrients 36 device that is used to spray the roots 34 of the plants with nutrients. It is understood that any device known in the art can be used to provide water 23 and plant intake nutrients as required.

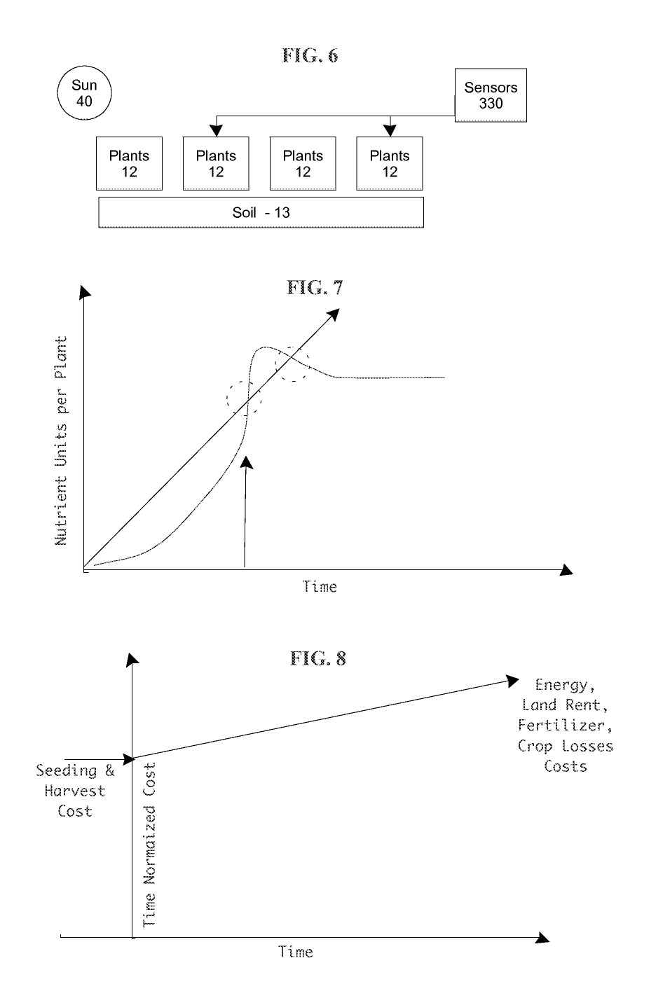

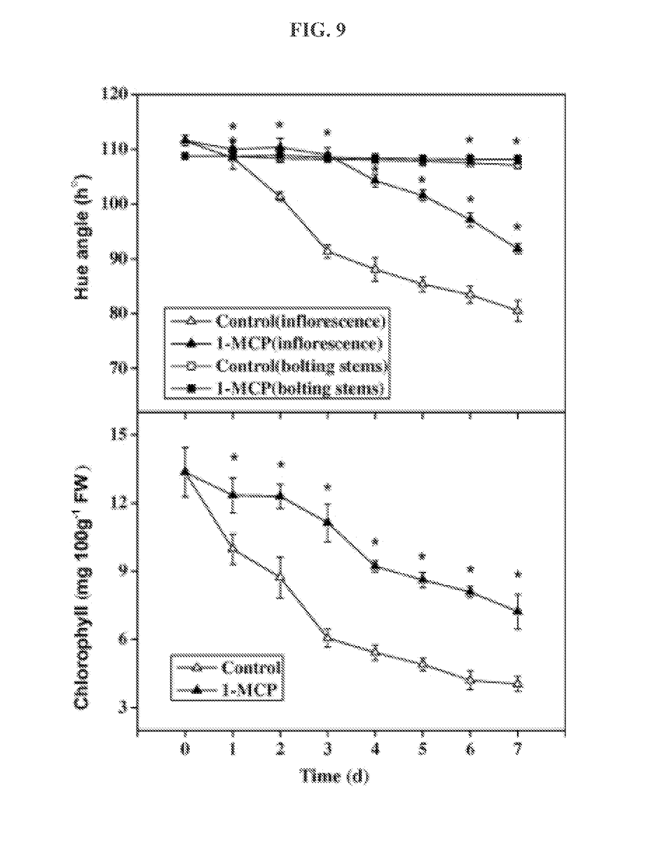

Turning to FIG. 6, FIG. 6 illustrates the nutrient optimization set-up for a uncontrolled farm. This diagram shows light as provided by the sun 40 to the plants 12. The diagram further shows the sensors 330 that are part of the optimization management system to determine nutrient optimization and time to harvest. The diagram also shows the soil 13 that the plants grow in.

Turning to FIG. 7, FIG. 7 is a X,Y graph that depicts the Nutrient Units per Plant on the Y axis and time on the X axis. Two dashed circles depict points of intersection on the 45 degree line, which is the method to depict the generally linear nature of growing costs assuming the seed planting on harvesting costs are placed at time zero. Harvesting costs are placed at time zero, even though it doesn't occur there, as the harvest associated costs are essentially independent of time both in the sense of duration and when it occurs. The first instance of the aggregate nutrient units per plant crosses the 45 degree line, without being bound by theory, as the plant enters into Phase II of its growth stage. The second instance of the aggregate nutrient units per plant returns back under the linear time line that is indicative of the plant being overripe or having experienced stress beyond its inherent ability to recover. It is understood that the Nutrient Units per Plant are the aggregate total of nutrients that accounts for the mass of the plant. The aggregate total of nutrients is the most critical parameter for the optimization management system as it is the most important reason for consumers consumption of vegetables and fruit. It is further understood that flavor compounds and nutrients are used interchangeably.

Turning to FIG. 8, FIG. 8 is a X,Y graph that depicts the Time Normalized Cost on the Y axis and time on the X axis. Harvesting costs are placed at time zero, even though it doesn't occur there, as the harvest associated costs are essentially independent of time both in the sense of duration and when it occurs. Cost over nutrients/time is an essential parameter that is critical in the determination of when to harvest plants. The gain in nutrients is a diminishing return when it is no longer worth the incremental cost of lighting (i.e., energy and capital amortization), labor and rent to keep it growing. The incremental cost of capital equipment amortization, energy, and land rent are highly linear as a function of time. Fertilizer when applicable and crop losses are approximately linear, and are typically included in the incremental costs. However, all costs other than the relatively fixed costs of seeding and harvest, can be incorporated into the Time Normalized Cost including the function being less than linear (as compared to the depicted highly linear function).

Turning to FIG. 9, FIG. 9 is graph from a study looking at nutrients, specifically chlorophyll, lost over time during the post-harvest period. Chlorophyll is continually lost as more time elapses. In two days 50% of the value of chlorophyll was lost in the Chinese kale plant studied. FIG. 9 Hue angle is clearly closely correlated with chlorophyll levels, thus indicative of a real-time sensor utilized for determining optimal harvest time and not just as an indicator of post-harvest nutrient levels. It is understood from this study that even the use of post-harvest additives, such as the indicative MCP, does not stop the loss of nutrients. Thus it is concluded that the only definitive way to significantly reduce nutrient loss is to significantly reduce post-harvest time.

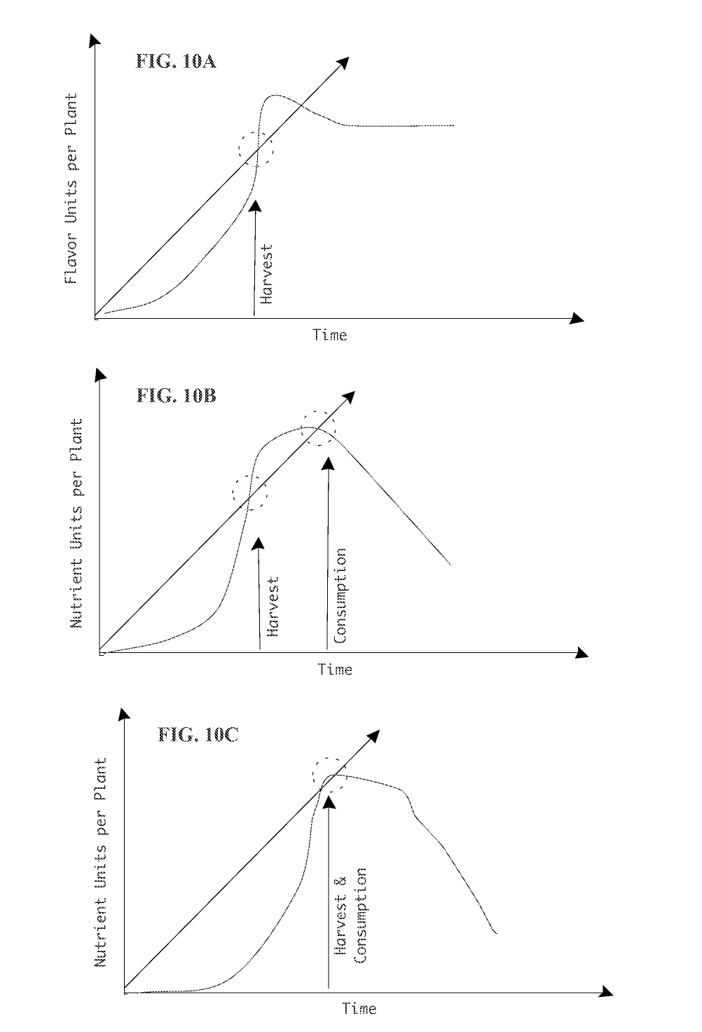

Turning to FIG. 10A, FIG. 10A is identical to FIG. 7 with the exception that Nutrient Units are replaced with Flavor Units.

Turning to FIG. 10B, FIG. 10B is identical to FIG. 7 with the exception that both an indicative harvest time and consumer consumption time are shown. Continued ripening post-harvest for a short duration prior to an aggressive onset of nutrient loss. The most important depiction in this figure is the intentional exaggeration of time between harvest time and consumption time.

Turning to FIG. 10C, FIG. 10C is identical to FIG. 10B with the exception that time between harvest and consumption is essentially eliminated. When known in advance that the harvest and consumption will occur concurrently, the harvest can occur at the absolute nutrient (and/or flavor) peak. This timing enables the optimal nutrient normalized cost for growing of the plant.

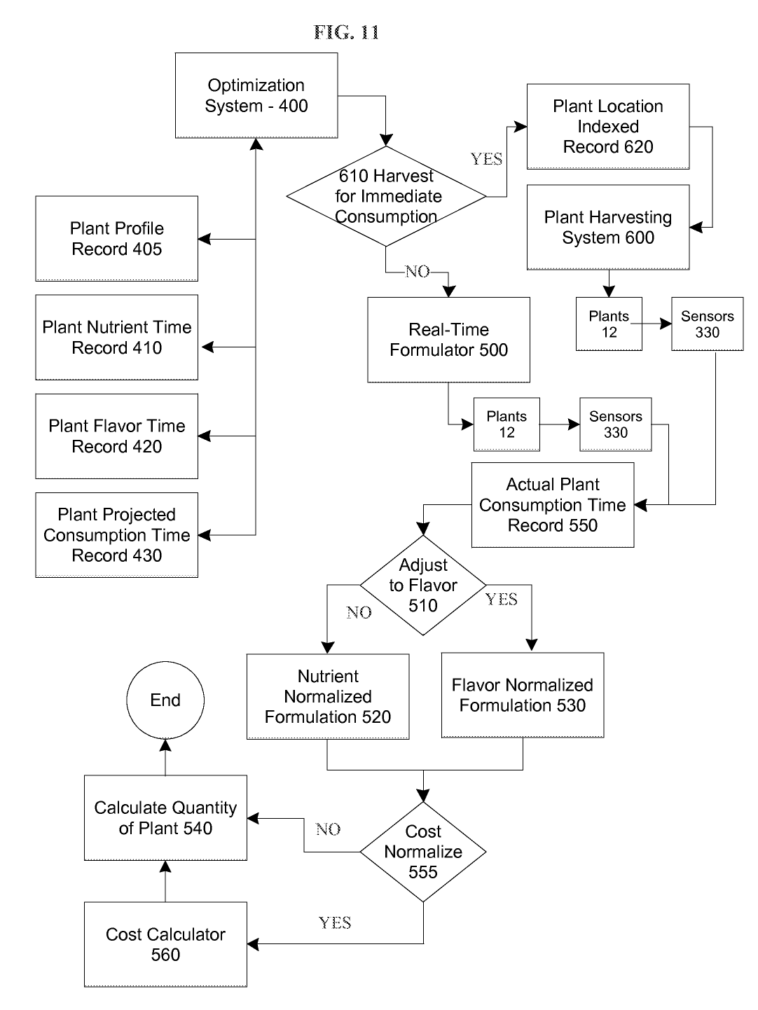

Turning to FIG. 11, FIG. 11 is identical to FIG. 11 the Optimization System 400 is comprised of multiple modules that include Plant Harvesting System 600, Nutrient Normalized Formulation 520, Flavor Normalized Formulation 530, Real-Time Formulator 500 and Cost Calculator 560. The Optimization System 400 is further comprised of database and its records including Plant Profile Record 405, Plant Nutrient Time Record 410, Plant Flavor Time Record 420, Plant Projected Consumption Time Record 430, Plant Location Indexed Record 620, and Actual Plant Consumption Time Record 550.

The Plant Profile Record 405 is a database record of growing parameters including optical profile at the beginning and ending of each growth phase (Phase 1 to Phase 2 to Phase 3). Additional parameters include plant density, particularly for the portion of the plant that is consumed (i.e., edible). Yet additional parameters include specific light spectrum requirements for each phase and the duration of each growth phase as a function of light spectrum and intensity.

The Plant Nutrient Time Record 410 maintains plant specific parameters notably the time domain function of nutrient levels on a mass basis. Additional parameters include nutrient levels on an aggregate light level basis, and nutrient levels on an aggregate light level basis for the important blue and red spectrums individually.

The Plant Flavor Time Record 420 maintains plant specific parameters notably the time domain function of flavor levels on a mass basis. Additional parameters include nutrient levels on an aggregate light level basis, and flavor levels on an aggregate light level basis for the important blue and red spectrums individually.

The Plant Projected Consumption Time Record 430 is a database record of consumer demand on a historic basis, with additional parameters utilized to update the projected consumer demand based on more current and real-time data. Each plant type has a record, and each record further is continuously updated with the time required to harvest and deliver to the consumer for consumption. The time required to harvest and deliver to the consumer is updated in conjunction with the Plant Harvesting System 600, which utilizes the precise location of the plant and the precise location and availability of logistics delivery vehicles (this can also include automated guided vehicles or automated storage retrieval system transports).

The Real-Time Formulator 500 is a computer program that modulates a food (or nutraceutical, or dietary supplement) formula based on precise sensor measurements to achieve specific functional performance (i.e., either or both of nutrient levels or flavor levels). The Real-Time Formulator 500 notably adjusts for nutrient level or flavor level density enabling the subsequent plant measurement and dosing systems to provide commands specific to the preferred unit of measure (e.g., mass, volume, surface area, etc.) for the dosing system.

The Plant Location Indexed Record 620 is a database that maintains most recent measurement with its associated time of measurement, the projected measurement based on Plant Profile Record 405 and actual time and conditions since that most recent measurement. The Plant Location Indexed Record 620 also maintains the precise physical location of each plant for the instance of partial harvesting the precise physical location of each plant harvest unit (e.g., leaf, fruit, vegetable, etc.).

The Plant Location Indexed Record 620 works in conjunction with the Plant Harvesting System 695 to update recent measurements of plants 12 utilizing Sensors 330 that are on the Plant Harvesting System 600 in the preferred embodiment.

The plants grown in the invented distributed farm optimization system is best utilized within a food formulation system to meet personalized recipes that modulate the ingredients used within the recipe in accordance to at least nutrient content and flavor content. The nutrient and flavor information obtained whether directly or indirectly via Sensor 330 is the fundamental basis to modulate recipe. R is understood within the art that a parameter obtained via Sensor 330 can be used to indirectly obtain a parametric estimation of nutrient level and/or flavor level. It is further understood that multiple parameters obtained via other sensors as known in the art can improve the accuracy in which the nutrient and flavor levels are approximated for modulating the usage levels within the personalized (or normalized) recipe. A sensor of either the same type as Sensor 330 or different type can be utilized immediately prior to the making/cooking of the recipe for the most accurate method to obtain the desired nutrient and/or flavor levels as formulated in the recipe. The recipe formulator has the ability to Adjust to Flavor 510 (also understood that this can be replaced or supplemented with Adjust to Nutrient) in which Nutrient Normalized Formulation 520 or Flavor Normalized Formulation 530 is performed. The basis as to which normalization takes place, or is preferred, is selected by the food preparer or the food consumer (in accordance to personal preferences). The use of certain nutrient rich plants have significant flavor impact, in which case both nutrient and flavor normalization are appropriate in order to make/create great tasting food. Other nutrient rich plants have limited flavor impact, in which case nutrient normalization is adequate in order to make/create great tasting food.

Another feature of the invention is to cost normalize the recipe, in accordance to preferences as determined by either the food preparer or consumer. When the Cost Normalize 555 process step is not selected, the recipe is prepared by providing the desired nutrient or flavor levels as formulated in the recipe regardless of the cost impact by achieving such levels. When the Cost Normalize, 555 process step is selected the Cost Calculator 560 is utilized to adjust nutrient and/or plant levels to stay within the food preparer or consumer cost range. In any event, the Calculate Quantity of Plant 540 step is included to determine the usage levels of the plant in order to meet nutrient and/or flavor formulations (as standard or including personalization). The calculation of quantity of plant, as known in the art, can be further adjusted by variations in mass density (i.e., measure by mass, volume, or color). Adjusting by portion of plant having a specific color density, etc. is anticipated as it is known in the art that nutrients and/or flavor in particular vary in accordance to the portion of the plant utilized (i.e., distinguish between plant root, leaf, stem, etc.).

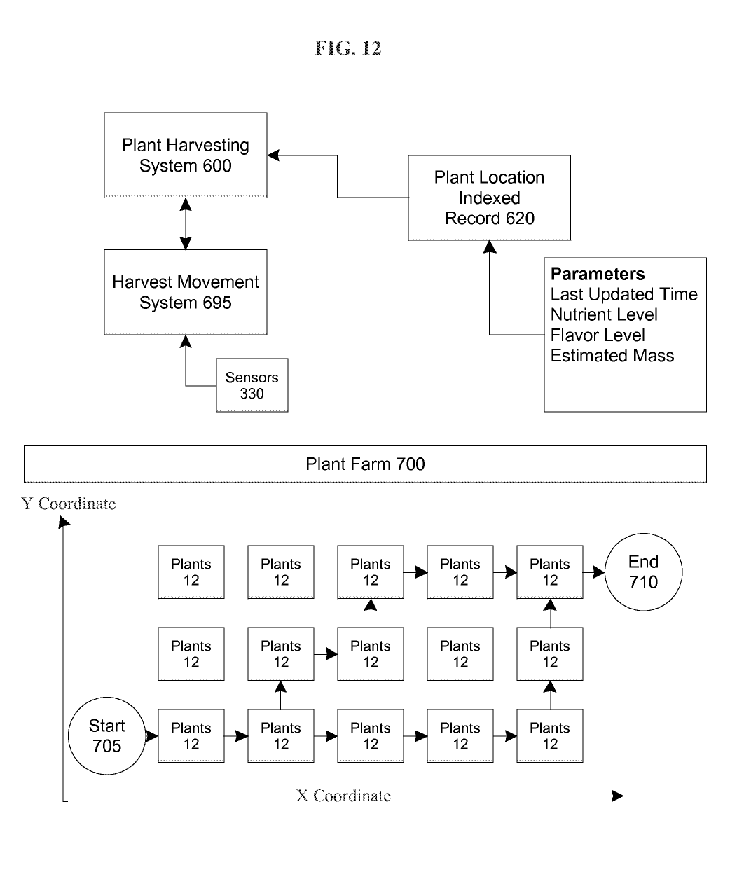

Turning to FIG. 12, FIG. 12 is comprised of an additional module that in the Plant Harvesting System 600, which further utilizes Plant Location Indexed Record(s) 620 that has numerous parameters including Last Updated Time, Nutrient Level and Flavor Level at that last updated time, and estimated mass of the plant (or portion of the plant that is nutrient or flavor rich) based on at least one of visual imaging, duration of growth cycle, etc. As disclosed earlier, the Plant Location indexed Record 620 works in conjunction with the Plant Harvesting System 600 to update recent measurements of plants 12 utilizing Sensors 330 that are on the Plant Harvesting System 600 in the preferred embodiment. It is understood that any roaming device is utilized in the Harvest Movement System 695, whether it be automated or manual, outfitted with a Sensor 330 can be used to move the Sensor 330 in order to obtain updated measurements. The particularly preferred Harvest Movement System 695 has a routing capability such that plants that have the longest of periods of time since recent measurement are routed to pass the plant in between the roaming device starting point and desired end point. The specifically preferred Harvest Movement System 695 has the further ability to prioritize amongst plants within the Phase 2 stage of growth (being the immediate stage before harvest). The Plant Farm 700, by way of example, can be organized in rows (X Coordinate) and columns (Y Coordinate). It is understood that any coordinate system can be utilized, including a Z dimension for height, to provide location. The figure depicts multiple paths (as shown by the arrows) between the Start 705 and End 710 position. It is further understood that routing between any start and end position can be optimized for travel time, or optimized by number of plants in which sensor measurements are updated.

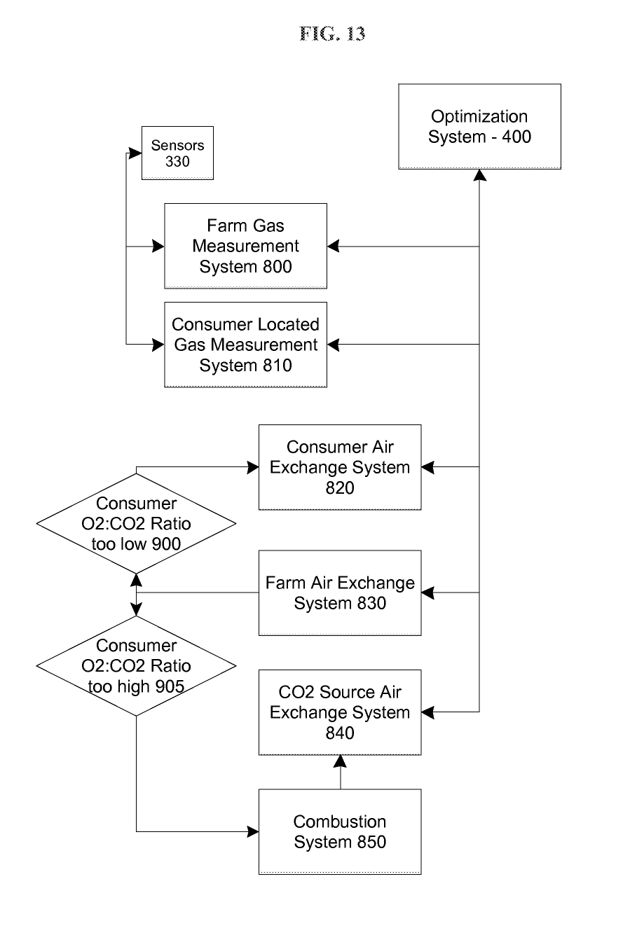

Turning to FIG. 13, FIG. 13 is a further module of the distributed farm optimization system by the inclusion of a gas optimization module Farm Gas Measurement System 800. It is known in the art that carbon dioxide “CO2” levels are important to plant growth. The disclosed invention being a distributed farm is either integral or directly co-located with people, where people consume oxygen and exhaust CO2. Plants produce oxygen “O2” as a byproduct of their growth, which now has the ability to be consumed by the co-located people. As such, the traditional metric of CO2 ppm determining the time of fresh air introduction is no longer the most relevant parameter. The most relevant parameter is now the invented oxygen to carbon dioxide ratio “O2:CO2” ratio. The Optimization System 400 as it controls O2:CO2 ratio measures both the O2:CO2 ratio within the farm by Farm Gas Measurement System 800 and within the people (i.e., consumer) Consumer Located Gas Measurement System 810 utilizing Sensors 330 as known in the art. The gas optimization process utilizes Consumer Air Exchanger System 820 and Farm Air Exchange System 830 to vary/direct airflow between the two locations, utilizing methods as known in the art including air-to-air exchanger (w/ and w/o humidity exchanger). During periods that the Consumer O2:CO2 ratio 900 is too low, airflow from the Farm Air Exchange System 830 is provided. This has the benefit of first removing excess oxygen from the farm and providing it to the consumer, thus minimizing the need to take in traditional fresh air (that is often too cold, too hot, or too humid). During periods that the Consumer O2:CO2 ratio 905 is too high, airflow from the Farm Air Exchanger System 830 is directed to the Combustion System 850. The co-location of the farm with a combustion system enhances the combustion efficiency by reducing the air mass flow requirements thus producing lower cfm exhaust (and thus lower cost and more efficient waste heat recovery). The subsequent combustion exhaust is directed to CO2 Source Air Exchanger System 840 for extraction of a richer source of CO2 relative to nitrogen of traditional inlet air.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A plant production system comprised of a plant in a growing stage, a cost basis in a time domain for the plant in the growing stage, the cost basis in the time domain includes harvesting costs and is operable to decrease growing cost normalized by an aggregate nutrient level on a combined cost basis including at least two cost parameters of energy, land rent, fertilizer and crop loss cost.

2. The plant production system according to claim 1 whereby the plant growth is comprised of a first early stage and a second mature stage.

3. The plant production system according to claim 1 further comprised of a plant pricing system based on the aggregate nutrient or flavor levels.

4. The plant production system according to claim 3 wherein the plant pricing system based on the aggregate nutrient or flavor levels has pricing established at the time of either plant consumption or delivery.

5. The plant production system according to claim 1 further comprised of a plant pricing system based on the aggregate nutrient or flavor levels.

6. The plant production system according to claim 1 wherein the plant growth is at a consumer consumption location operable to minimize post harvest loss of at least one of nutrient or flavor level.

7. The plant production system according to claim 1 further comprised of a motion based harvesting system having an onboard real-time nutrient measurement sensor and a database record having at least three parameters including recent measurement time, nutrient or flavor level, and location coordinates.

8. The plant production system according to claim 1 further comprised of a recipe formulation modulator whereby the formulation modulator normalizes the recipe in a real-time basis on a nutrient or flavor basis.

9. The plant production system according to claim 2 further comprised of a nutrient or flavor blasting system to maximize nutrient or flavor levels during the second mature stage of plant growth.

10. The plant production system according to claim 9 wherein the nutrient or flavor blasting system is further comprised of a projected or actual plant consumption historic or predictive database record operable to predict the beginning and ending of the nutrient or flavor blasting period.

11. The plant production system according to claim 10 further comprised of a fully time amortized cost basis, and wherein the nutrient or flavor blasting system begins and ends the nutrient or flavor blasting period for consumer consumption to reach the inflection point of nutrient or flavor normalized over the fully time amortized cost basis.

12. The plant production system according to claim 11 wherein the fully time amortized cost basis includes harvest costs placed at time zero.

13. The plant production system according to claim 1 further comprised of a database record having growing parameters including optical profile at the beginning and ending of the first early stage and the second mature stage of plant growth.

14. The plant production system according to claim 7 further comprised of a routing system between the plant start point and the plant end point whereby the route taken maximizes the updating of the most number of plants with the latest most recent nutrient or flavor measurement time.

15. The plant production system according to claim 1 further comprised of a gas optimization module measuring an oxygen to carbon dioxide ratio whereby the gas optimization module varies air flow between a farm location growing the plant and a location in which the consumer consumes the plant.

16. The plant production system according to claim 15 further comprised of an airflow exchanger operable to minimize energy consumption.

17. A method for operating a plant production system according to claim 1 having a control system operable to regulate the nutrient or flavor level at a minimum growing cost basis within a time domain basis.

18. A method for operating a plant production system according to claim 1 having a control system operable to regulate the nutrient or flavor level at a maximum nutrient or flavor level at the plant consumption time domain.

19. A method for operating a plant production system according to claim 1 having a control system operable to regulate the nutrient or flavor level at a maximum nutrient or flavor level within a controlled farm.

20. A method for operating a plant production system according to claim 1 having a control system operable to regulate the nutrient or flavor level at a maximum nutrient or flavor level within an uncontrolled farm.
